(19) United States
(12) Patent Application Publication
(10) Pub. No.: US 2009/0040269 A1
(43) Pub. Date: Feb. 12, 2009

(54) Droplet Applicator

(75) Inventors: Yoshinori Nakajima, Nara (JP); Kaoru Higuchi, Nara (JP); Yasuhiro Sakamoto, Osaka (JP); Sigemi Asai, Kyoto (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 12/087,162

(22) PCT Filed: Dec. 28, 2005
(86) PCT No.: PCT/JP2005/024056

§ 371 Date: Jun. 27, 2008

(51) Int. Cl. B41J 23/00

(52) U.S. Cl. 347/37

(57) ABSTRACT

A droplet applicator (1) includes a conveying stage (11) and beams (12). The conveying stage (11) holds a substrate (50) and can reciprocate in second directions, in which the substrate is conveyed. The beams (12) are substantially parallel to first directions perpendicular to the second directions. Each beam (12) is fitted with droplet discharge units (2), which face the substrate (50). Each droplet discharge unit (2) can be moved independently in the first directions within a range of movability by a slider (20).

### TECHNICAL FIELD

The present invention relates to a droplet applicator of the ink jet type or another type for applying droplets to a substrate.

### BACKGROUND ART

In recent years, ink jet technology is expected to be used for not only printers, which form images on paper, but also manufacturing apparatus. For example, Patent Document 1 discloses the structure of an apparatus for manufacturing liquid crystal displays, organic EL displays, plasma displays, electron emitting elements, electrophoretic displays, or the like. This apparatus is fitted with droplet discharge elements of the ink jet type. In order for this apparatus to discharge ink to a substrate with higher positional accuracy, a granite bed as the base of the apparatus is fitted with a stage for conveying a substrate in one direction and a carriage for moving an ink jet head perpendicularly to this direction.

A general purpose ink jet printer is fitted with ink jet head elements, which discharge ink droplets. In general, such a head element has a width of ½-2 inches and nozzle holes arrayed at regular intervals of 150-300 nozzles per inch. Some of the head elements are allotted to each color. The head elements form parts of an ink jet head unit for forming an image. While the feed roller of the printer is feeding recording paper in a feeding direction, the head unit reciprocates for scanning a number of times perpendicularly to the feeding direction, thereby forming an image on the paper.

Even if an ink jet type apparatus is used as a manufacturing apparatus as described above, ink jet head elements can be used for it as is the case with general printers. In the present circumstances, however, the size of the head elements along their nozzle rows is merely about 1-2 inches.

For processes for manufacturing liquid crystal displays, organic EL displays, plasma displays, electron emitting elements, and electrophoretic displays, large area substrates tend to be used so that a large number of substrates can be produced. This lowers the cost of production and shortens the tact. In order to manufacture liquid crystal displays, organic EL displays, plasma displays, electron emitting elements, and electrophoretic displays, there has been a demand for ink jet type apparatus which can process large area substrates having lengths and widths of some meters.

A piece of such ink jet type apparatus which can process large area substrates at high speed may be a line head type apparatus having an array of ink jet head elements which is longer than the size of substrates. This apparatus has a zigzag array of ink jet elements each having a width of about 1-2 inches. The length of the zigzag array is equal to the substrate size. Accordingly, if the substrate size is some meters, at least 100-200 heads need to be arrayed. It can be said that this apparatus is very desirable for making a color filter substrate or the like over the whole of which ink needs to be discharged at regular intervals on the substrate or the like.

If ink is discharged over the whole of a color filter substrate, it is necessary to repair defectively colored spots on the substrate. Patent Document 2 discloses an apparatus which discharges color filter material only to defectively colored spots on a color filter substrate.
Patent Document 1: JP 2003-191462 A
Patent Document 2: JP 2003-66218 A

### DISCLOSURE OF INVENTION

### Problems to be Solved by the Invention

However, the line head type apparatus is inconvenient for repairing defectively colored spots on a color filter substrate after ink is discharged over the whole substrate. The line head type apparatus may be used as a means for repairing defectively colored spots on a color filter substrate. In this case, it takes the same time to repair the defectively colored spots as it takes to discharge droplets over the whole substrate. In addition, most nozzles of this apparatus are non-operating nozzles, which discharge no droplet and are liable to be clogged up. Maintenance needs to be done on all the nozzles, inclusive of the non-operating nozzles, of the apparatus, increasing the amount of waste liquid. originally, it is essential to discharge droplets only to defectively colored spots on a color filter substrate. However, the line head type apparatus is very inefficient because it needs to make discharge corrections for all its (thousands of) nozzles so as to uniformize the discharge from the nozzles.

In many general printers, an ink jet head unit reciprocates a number of times along a line. The head unit scans along distance. From the point of view of stable operation, there is an upper limit to the scanning speed of the head unit. These make it impossible to shorten the processing time.

Not only for the repair of color filters, but also in various manufacturing fields, there may in the future be demands that droplets be discharged efficiently to desired spots on large area substrates. However, it is difficult for such demands to be met by the line head type apparatus and the printers in which an ink jet head unit reciprocates along a line.

An object of the present invention is to provide a droplet applicator which can efficiently discharge droplets to desired spots on a large area substrate.

Another object of the present invention is to provide a droplet applicator which can efficiently discharge droplets not only to desired spots on a large area substrate but also over the whole of the substrate.

### Means for Solving Problem

The present invention comprises droplet discharge units and a moving mechanism. The droplet discharge units face a substrate and can move independently in first directions over the substrate. The droplet discharge units apply droplets to specified spots on the substrate by discharging the droplets onto it. The moving mechanism moves the droplet discharge units relatively in second directions perpendicular to the first directions. The droplet discharge units move to any positions over the substrate and discharge droplets.

A stage can reciprocate in the second directions and holds the substrate. Carriers carry the droplet discharge units over the stage and are substantially parallel to the first directions.

In another embodiment of the present invention, the carriers include sliders each enabling one of the droplet discharge units to move independently. The sliders are so fitted to the carriers that the ranges of movability within which the sliders enable the droplet discharge units to move overlap in the first directions. This makes it possible to discharge droplets at any positions in the first directions over the substrate.

### EFFECTS OF THE INVENTION

It is possible to shorten the processing time taken by droplets to be discharged onto desired spots on a substrate. It is also possible to reduce the number of non-operating nozzles, thereby reducing the quantity of waste liquid. It is easy to drop a stable quantity of droplets.

### BRIEF DESCRIPTION OF THE DRAWINGS

FIG. 1 is drawings of a droplet applicator according to embodiment 1 of the present invention.

FIG. 2 is a perspective view of the droplet applicator according to embodiment 1 of the present invention.

FIG. 3 is drawings showing the order of droplet discharge in embodiment 1 of the present invention.

FIG. 4 is a drawing showing the operation of the droplet applicator according to embodiment 1 of the present invention.

FIG. 5 is a drawing showing the operation of the droplet applicator according to embodiment 1 of the present invention.

FIG. 6 is a drawing showing the operation of the droplet applicator according to embodiment 1 of the present invention.

FIG. 7 is a type section showing the maintenance unit of embodiment 1 of the present invention.

FIG. 8 is a drawing of a droplet applicator according to embodiment 2 of the present invention.

FIG. 9 is drawings showing the structure of the droplet discharge units of embodiments 1-3 of the present invention.

FIG. 10 is drawings showing arrays of droplet discharge units of embodiments 1-3 of the present invention.

FIG. 11 is a drawing of a droplet applicator according to embodiment 3 of the present invention.

FIG. 12 is a drawing showing the operation of the droplet applicator according to embodiment 3 of the present invention.

### EXPLANATION OF REFERENCE NUMBERS

1 a droplet applicator
2 droplet discharge units
10 a base
11 a conveying stage
12 beams
13 a maintenance unit
20 sliders
21 discharge elements
50 a substrate

### BEST MODE FOR CARRYING OUT THE INVENTION

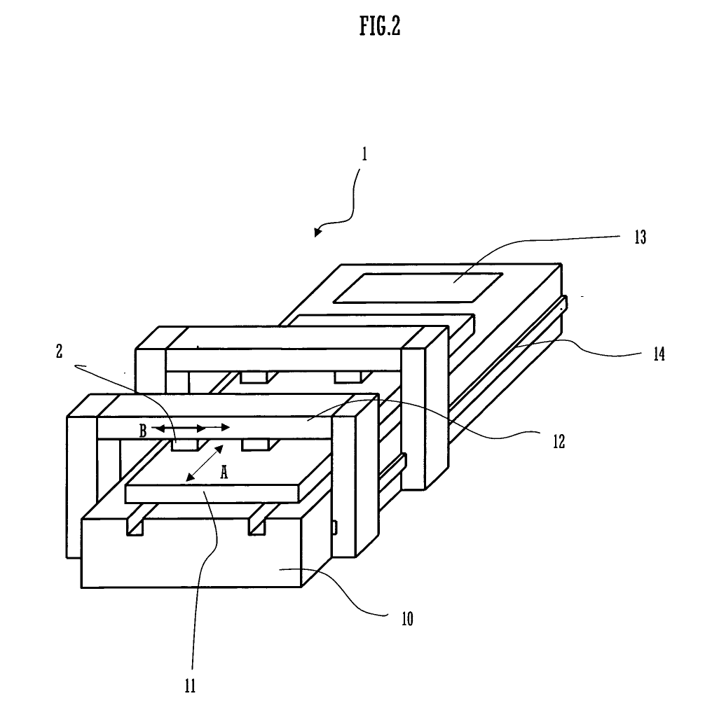

FIG. 2 is a perspective view of a droplet applicator 1 according to an embodiment of the present invention, showing only the characterizing parts of the applicator.

The droplet applicator 1 consists of a base 10, which is a granite bed, a conveying stage 11, and beams (carriers) 12 in the form of gates. The conveying stage 11 can move in (second) directions A on the base 10. The beams 12 are connected to the side surfaces of the base 10 and span it across the conveying stage 11. Each beam 12 is fitted with droplet discharge units 2 by means of sliders 20 (not shown), each of which enables one of the units 2 to move independently in (first) directions B.

In this embodiment, the droplet discharge units 2 are ink jet units, which discharge ink droplets.

The discharge faces of the droplet discharge units 2 face the conveying stage 11. A substrate 50 which needs restoring can be mounted on the conveying stage 11. With the substrate 50 mounted on the conveying stage 11, the gap between the upper surface of the substrate 50 and the discharge face of each droplet discharge unit 2 is about 0.1-0.5 mm. The base 10 is fitted with a maintenance unit 13 on it, which includes a mechanism for capping the discharge faces of the droplet discharge units 2 while these units are not used, a mechanism for detecting a defective discharge nozzle, a mechanism for restoring a defective discharge nozzle, and other mechanisms. If maintenance needs to be done on one of the droplet discharge units 2, this unit 2 is shifted toward the maintenance unit 13. With the shifted discharge unit 2 facing the maintenance unit 13, maintenance is done on the discharge unit 2. In this embodiment, a beam shifter 14 shifts the beams 12 toward the maintenance unit 13.

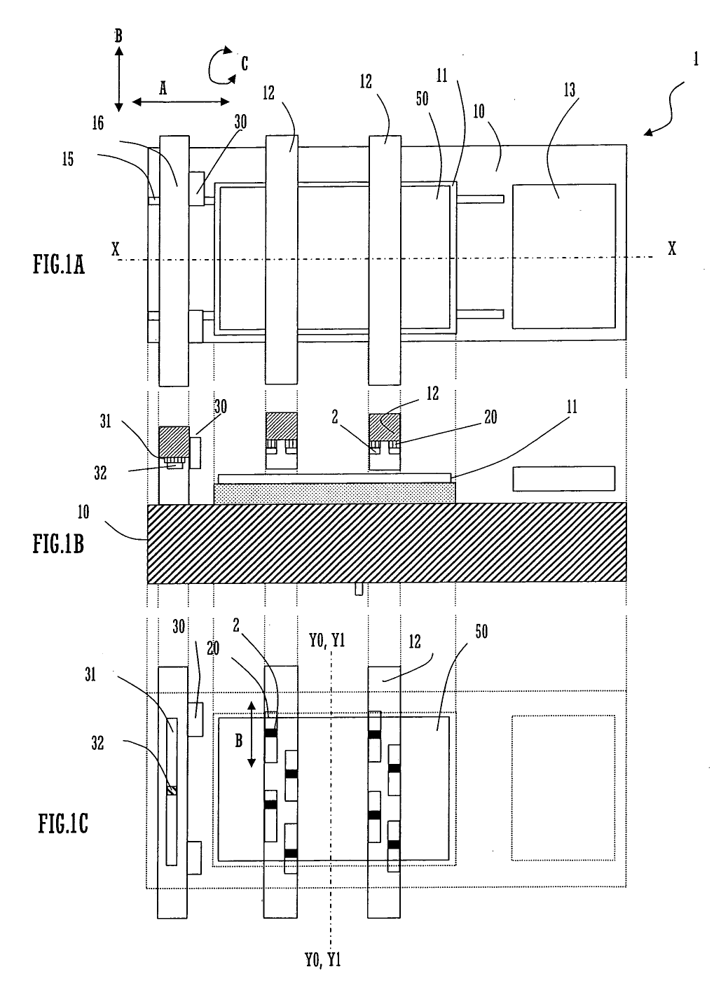

A carrying robot (not shown) carries, from the left in FIG. 1, a substrate 50 which needs restoring. The carried substrate 50 is placed on the conveying stage 11. The conveying stage 11 is fitted with a mechanism for fixing a substrate 50 on the stage by means of vacuum adsorption or the like. While the conveying stage 11 is reciprocating in the (second) directions A, the droplet discharge units 2 move independently of each other in the (first) directions B, which are perpendicular to the directions A, and discharge droplets at any times. While the conveying stage 11 is reciprocating a number of times in the directions A, the droplet discharge units 2 move in the directions B so as to discharge droplets to desired spots on the substrate 50.

FIG. 1 shows the droplet applicator 1 according to embodiment 1 of the present invention in detail. FIG. 1(A) is a top plan of the applicator 1. FIG. 1(B) is a cross section along line X-X of FIG. 1(A). FIG. 1(C) is a perspective view from the back side of the base 10 in the direction indicated by the arrow in FIG. 1(B).

With reference to FIG. 1(A), the base 10 is a granite bed. The upper surface of the base 10, which supports the conveying stage 11, is high in evenness and has a flatness of 0.5 or less mm. The base 10 is fitted with a parallel adjustment mechanism (not shown) at its portion in contact with a floor. The parallel adjustment mechanism makes the normals to the upper surface of the base 10 vertical. The droplet applicator 1 has a width of about 2-4 m and a length of about 5-7 m. The base 10 has slide rails 15 formed on its upper side. The conveying stage 11 is supported on the upper side of the base 10 and can be reciprocated in the directions A along the slide rails 15 by a linear motor. A θ turning mechanism (not shown) is fitted between the conveying stage 11 and slide rails 15. Specifically, the θ turning mechanism is fitted on the same moving mechanism for the conveying stage 11. The conveying stage 11 is a granite bed, the upper surface of which is high in evenness. The normals to the upper surface of the conveying stage 11 are substantially vertical. The conveying stage 11 has pores (not shown) formed on its upper side, all of which are connected to a suction/blast mechanism (not shown) so that the substrate 50 on the stage 11 can be fixed adsorptively and released from the stage 11 by means of suction/blast control.

Thus, it is possible to adjust the turning of the conveying stage 11 (in directions C in FIG. 1) on a plane on the base 10, with the substrate 50 held on the stage 11, and to move the stage 11 freely in the directions C and A, with the normals to its upper surface kept substantially vertical.

The structure of the maintenance unit 13 on the base 10 will be described later on in detail.

The droplet applicator 1 includes two beams 12 in the form of gates, which span the base 10 across the conveying stage 11. The beams 12 include pillars, which extend substantially vertically from the side surfaces of the base 10. The beams 12 are positioned substantially in parallel with each other at a pitch which is about a half of the length of the conveying stage 11. If the length of the conveying stage 11 is 3 m, the beams 12 are positioned in parallel at an interval of 1.5 m. The beams 12 are made by grinding calcined ceramics and support the droplet discharge units 2. The sliders 20, which move the droplet discharge units 2, are fitted on the under sides of the beams 12. At least the under sides of the beams 12 have a flatness of 0.5 or less mm.

A substrate 50 can be placed on the conveying stage 11 from the left side of the droplet applicator 1 in FIG. 1. The droplet applicator 1 further includes a monitoring beam 16 positioned on its left side in FIG. 1. The monitoring beam 16 takes the form of a gate and is substantially identical in shape with the beams 12. The monitoring beam 16 is fitted with three cameras on it, which can monitor the upper side of the substrate 50 mounted on the conveying stage 11. The cameras are two alignment cameras 30 and a substrate monitoring camera 32. The alignment cameras 30 are fixed to the monitoring beam 16, along which the monitoring camera 32 can move.

The process from the placement of a substrate 50 to droplet discharge will be summarized as follows.

First, the conveying stage 11 is shifted to the leftmost position in FIG. 1 to which it can shift. Subsequently, the carrying robot (not shown) places a substrate 50 on the conveying stage 11. The adsorption pores in the conveying stage 11 adsorb the placed substrate 50. Next, while the conveying stage 11 is moved right and left in FIG. 1, the two alignment cameras 30 monitor an edge or a characterizing pattern part of the substrate 50. This makes it possible to find out the position of the substrate 50 relative to the droplet applicator 1 and align the substrate 50 by so driving the θ turning mechanism of conveying stage 11 as to correct the θ misalignment in the moving directions between the substrate 50 and the stage 11.

FIG. 1(B) is a cross section of the droplet applicator 1. The sliders 20 extend along the under sides of the beams 12, which face the substrate 50. The sliders 20 support the droplet discharge units 2.

FIG. 1(C) is a perspective view of the droplet applicator 1, showing the applicator, with the base 10 removed from its bottom. Each of the beams 12 is fitted with sliders 20, each of which supports one droplet discharge unit 2. Each droplet discharge unit 2 can be moved on the associated slider 20 along the associated beam 12 (in the directions B) by a linear motor (not shown).

Thus, the droplet discharge units 2 can move independently of each other along the beams 12 (in the directions B). Each of the beams 12 is fitted with four droplet discharge units 2 on it. The range within which each droplet discharge unit 2 can move in the directions B overlaps with the range or ranges within which the adjacent unit or units 2 can move in these directions. This makes it possible to discharge droplets at any spots along the substrate 50 (in the directions B).

Accordingly, any one of the four droplet discharge units 2 can be moved to any position over the conveying stage 11 longitudinally of the stage (in the directions B). Herein, each set of droplet discharge units 2 which can be moved longitudinally (in the directions B) to any position is defined as a unit row. Each of the two beams 12 is fitted with one unit row, so that the droplet applicator 1 is fitted with two unit rows in total. More specifically, the range within which each droplet discharge unit 2 can move means the range within which the droplet discharge nozzles of the unit can move.

The monitoring beam 13 is fitted with a slider 31, on which the substrate monitoring camera 32 is supported movably.

The two beams 12 are positioned on both sides of and at an equal distance from an intermediate line Y0-Y0. The center line Y1-Y1 of the conveying stage 11 reciprocates to the right and left of the intermediate line Y0-Y0 at an amplitude which is about a quarter of the length of the conveying stage 11. While the conveying stage 11 is reciprocating, each droplet discharge unit 2 on the associated beam 12 moves in the directions B and stops in any position, where the unit 2 stands by until the stage reciprocation causes a desired spot on the substrate 50 to reach the position under the discharge region of the unit 2. When the desired spot on the substrate 50 reaches the position under the discharge region of the droplet discharge unit 2, this unit is driven to discharge droplets to the spot.

A description will be provided of the process by which the droplet discharge units 2 discharge droplets into rectangular recesses. For example, if the substrate 50 is a color filter substrate having defects, they can be repaired by this process. For simplification of the description, all the droplet discharge units 2 will be described as units for discharging droplets of the same material. Specifically, the droplet applicator 1 will be described below as an apparatus for repairing defective pixels of one of three colors (red, blue, and yellow). Defective pixels of all the colors could be repaired serially by three droplet applicators 1, each for one of the colors. Alternatively, for that purpose, as exemplified by embodiment 2, which will be described later on, the droplet discharge units 2 could be units which can discharge droplets of different colors.

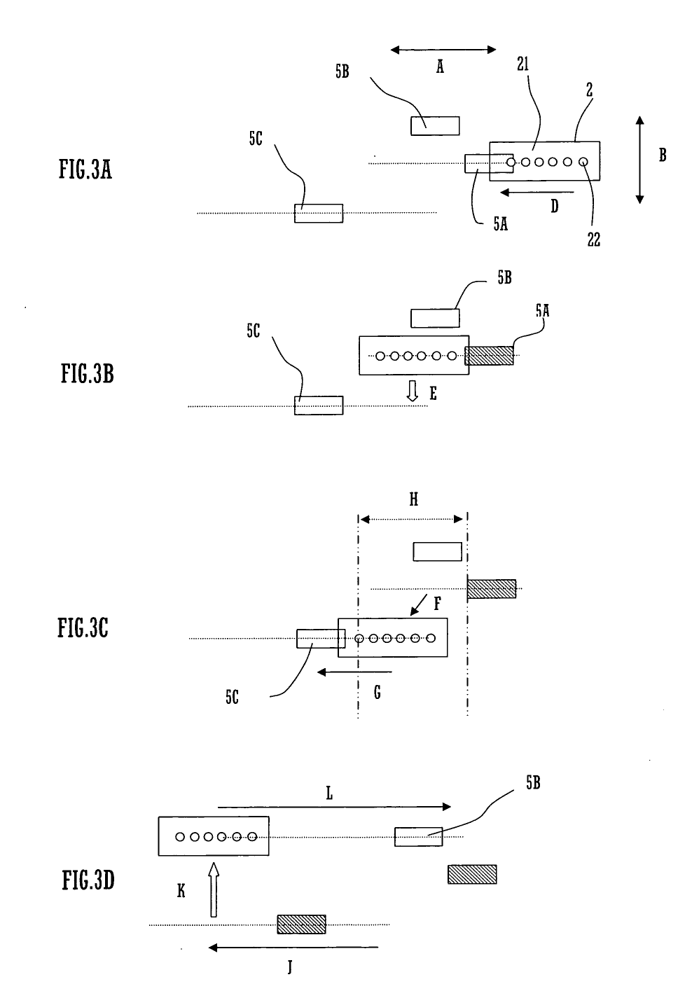

Like FIG. 1(C), FIG. 3 is perspective views of part of the substrate 50 from the bottom of the droplet applicator 1, showing in time series the discharge from one of the droplet discharge units 2 to defects (discharge points). In FIG. 3, attention is paid to one of the droplet discharge units 2 on the beams 12. The directions A and B in FIG. 3 are coincident with the directions A and B respectively in FIG. 1.

With reference to FIG. 3, defects 5 in the substrate 50 are recesses which are about 2 μm in depth. The opening of each of the recesses is rectangular and extends in the directions (A) in which the conveying stage 11 moves. The recess opening is about 200 μm in length and about 70 μm in width. The plane of the nozzle discharge element 21 of each droplet discharge unit 2 is parallel to the plane of the conveying stage 11. The nozzle discharge element 21 has nozzle holes 22 formed through it. The nozzle holes 22 are arrayed in the directions (A) in which the conveying stage 11 moves. Each droplet discharge unit 2 has ink pressure chambers (not shown) formed on its back side and pressure control means (not shown) fitted on this side. The ink pressure chambers and pressure control means can control droplet discharge. Each nozzle hole 22 of each droplet discharge unit 2 is connected to one of the associated pressure chambers and one of the associated control means. The row of nozzle holes 22 of each droplet discharge unit 2 can discharge droplets of the same material. The conveying stage 11 keeps reciprocating in the directions A at a substantially uniform speed independently of the movement of and the discharge from the droplet discharge units 2.

In order to repair a defect 5A by discharging droplets into it, one of the droplet discharge units 2 is moved at a high speed in the directions B by the associated slider 20 and stopped when the axes of the nozzle holes 22 of the unit 2 are positioned on the center line of the defect 5A. The time taken by each droplet discharge unit 2 to move is based on the sum of the time taken by it to actually move and the time taken by the associated slider 20 to stabilize. Each slider 20 makes a residual vibration after the associated discharge unit 2 stops. Therefore, it is necessary to take account of the stabilization time taken by the residual vibration to weaken to a level at which it does not adversely affect the droplet discharge from the droplet discharge unit 2. After the axes of the nozzle holes 22 are positioned on the center line of the defect 5A, the droplet discharge unit 2 is moved in a direction D relatively by the movement of the conveying stage 11 at the uniform speed, and the nozzle hole or holes 22 over the defect 5A discharge a droplet or droplets. In order to discharge droplets into the defect 5A, the two or more nozzle holes 22 over the defect can be used. Accordingly, as compared with a case where one nozzle hole 22 is used, it is possible to increase the uniform speed at which the conveying stage 11 moves. This makes it possible to improve the speed at which all the defects in the substrate 50 can be repaired.

After the droplet discharge unit 2 discharges droplets into the defect 5A, the unit 2 moves to repair another defect 5C, as shown in FIG. 3(B). Specifically, the driving of the slider 20 moves the droplet discharge unit 2 in a direction E so as to position the axes of the nozzle holes 22 on the center line of the defect 5C. While the droplet discharge unit 2 is moved in the direction E, the conveying stage 11 moves at the uniform speed to the left in FIG. 3. As a result, apparently, the droplet discharge unit 2 moves relatively in a direction F in FIG. 3(C). When the axes of the nozzle holes 22 are positioned on the center line of the defect 5C, the droplet discharge unit 2 stops moving in the directions B. Subsequently, while the droplet discharge unit 2 is moved relatively in a direction G by the movement of the conveying stage 11 at the uniform speed, the nozzle hole or holes 22 over the defect 5C discharge a droplet or droplets, repairing the defect.

After the conveying stage 11 has moved in one direction, it starts moving in the opposite direction. In order to repair a defect 5B, as shown in FIG. 3(D), the droplet discharge unit 2 is moved in a direction K by the slider 20 and stopped when the axes of the nozzle holes 22 are positioned on the center line of the defect 5B. Then, the droplet discharge unit 2 is moved in a direction L relatively by the movement of the conveying stage 11, and the nozzle hole or holes 22 over the defect 5B discharge a droplet or droplets into the defect. In order to repair the defect 5B after the defect 5C is repaired, the droplet discharge unit 2 might be moved in the directions B by the slider 20 at the same time that the conveying stage 11 moves at the uniform speed in the directions A. In this case, the droplet discharge unit 2 could be moved obliquely right and up toward the defect 5B, as moved in the direction F (FIG. 3(C)).

As shown in FIG. 3, the reciprocation of the conveying stage 11 is utilized to repair the three defects 5A, 5C and 5B in that order. This takes maximum advantage of the structure of the droplet applicator 1, as explained below.

With reference to FIG. 3(A), when two or more nozzle holes 22 of the droplet discharge unit 2 discharge droplets into the defect 5A, the unit 2 cannot move in the directions B until the right end nozzle hole 22 leaves its position over the defect 5A. In other words, the droplet discharge unit 2 cannot move in the directions B until all the nozzle holes 22 have passed the defect 5A. A limited number of nozzle holes 22 of the droplet discharge unit 2 may be used to repair a defect. In this case, the droplet discharge unit 2 cannot be moved in the directions B until both end nozzle holes 22 of these holes have passed the defect 5A. A limited number of nozzle holes 22 of the droplet discharge unit 2 are used if the unit discharges a small quantity of droplets. The droplet discharge unit 2 moves in the directions A within a range of disability H until the unit 2 can discharge droplets into the next defect 5C. With reference to FIG. 3(C), the range of disability H is upstream from the defect 5C, which needs repairing next, in the direction in which the conveying stage 11 moves. With reference to FIG. 3, the range of disability H extends from the left end of the defect 5A as just repaired and can be found from the sum of the distance between the end nozzle holes 22 and the distance over which the droplet discharge unit 2 moves in the directions A by moving in the direction F after it has discharged droplets into the defect 5A and until it can discharge droplets into the defect 5C. The time taken by the droplet discharge unit 2 to move in the direction F includes the time taken by residual vibration to stabilize after the unit 2 moves in the directions B.

With reference to FIG. 3, the repair of the defect 5A is followed by the repair of the defect 5C, which is out of the range of disability H for the defect 5A after this defect is repaired. After the defect 5A is repaired, as shown in FIG. 3(C), the defect 5B cannot be repaired because it is in the range of disability H. After the defect 5C is repaired, the defect 5B, which is out of the range of disability H for that defect, is repaired while the conveying stage 11 is returning.

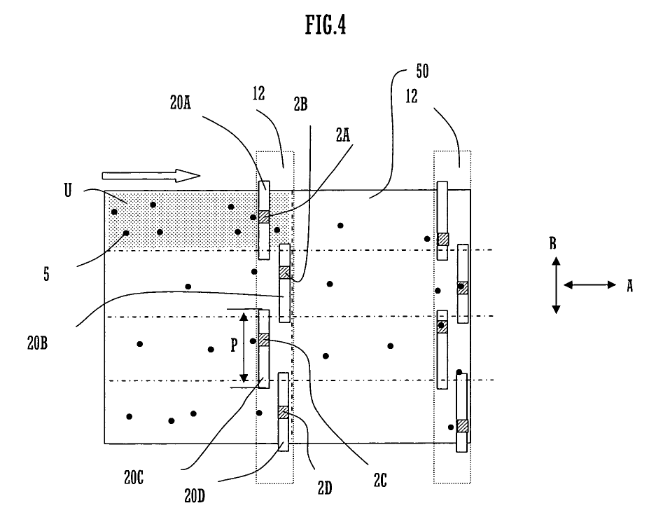

Although the movement and operation of one of the droplet discharge units 2 have been described above, each of them operates independently. FIG. 4 is a drawing showing the positional relations between the beams 12, sliders 20, droplet discharge units 2 and substrate 50 on the droplet applicator 1. FIG. 4 shows the relations between these elements positioned when the substrate 50 on the conveying stage 11 has moved from the substrate carrying side on the left in FIG. 4 in the direction indicated by the white arrow.

Each of the two beams 12 supports four droplet discharge units 2, each of which can be moved along the associated beam 12 (in the directions B) by the associated slider 20. Each droplet discharge unit 2 can move over the moving range P along the associated slider 20. The moving ranges P along each slider 20 (for example, 20C) and a slider 20 (for example, 20D) adjacent to it in the directions A overlap in the directions (B) perpendicular to the directions (A) in which the conveying stage 11 moves. Accordingly, the ranges in the directions B where droplets can be discharged are complemented with the droplet discharge units 2. Any one of the droplet discharge units 2A, 2B, 2C and 2D on each beam 12 can surely move in the directions B.

If each set of droplet discharge units 2 is defined as a unit row, there are two unit rows in this embodiment. Each of the unit rows consists of four droplet discharge units 2. The substrate 50 has defects 5, which are shown as black spots in FIG. 4. The area of the substrate 50 is divided equally into columns each for one of the unit rows, and into lines each for one of the droplet discharge units 2 of each of the unit rows. In the example shown in FIG. 4, the whole area of the substrate 50 is divided equally into regions, each of which belongs to one of four lines and one of two columns (4 lines×2 columns). Each of the regions is allotted to one of the droplet discharge units 2. For example, the region U hatched in FIG. 4 is allotted to the droplet discharge unit 2A, which repairs only the defects 5 in this region U.

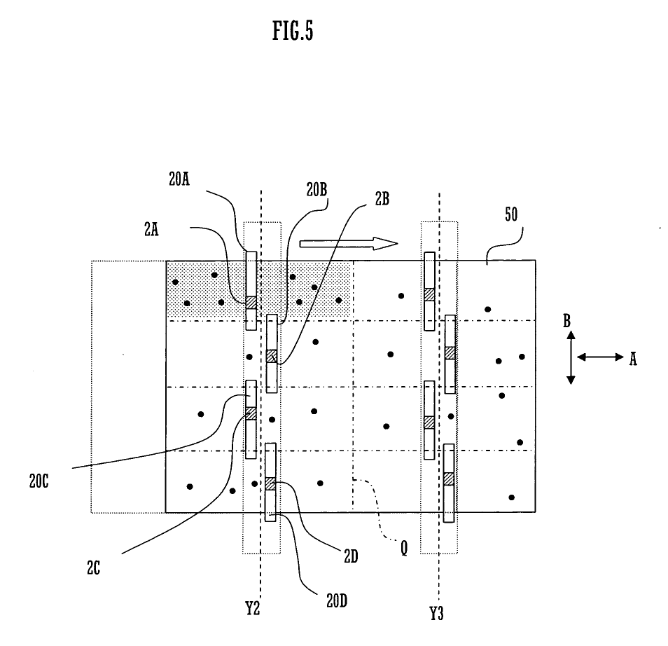

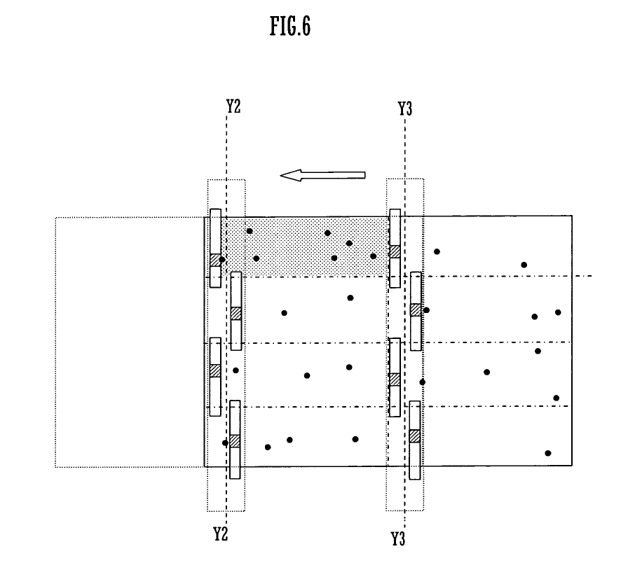

FIG. 5 shows the substrate 50 having been moved by the conveying stage 11 over half of the whole distance over which the substrate moves forward in the direction indicated by the white arrow in FIG. 5. FIG. 6 shows the substrate 50 having just started to return after it stops moving forward. With reference to FIG. 6, the substrate 50 moves in the direction indicated by the white arrow and returns to its position shown in FIG. 4. The conveying stage 11 repeats this reciprocation one or more times according to the number of defects, so that all the defects in the substrate 50 are repaired. The area of the substrate 50 may be divided into eight regions, each of which may be allotted to one of the droplet discharge units 2. In this case, the substrate 50 repeats the reciprocation until all the defects 5 are repaired, although one or some of the droplet discharge units 2 may have repaired the associated defect or defects 5 at a certain time due to the differences in the number of defects among the regions.

As shown in FIGS. 5 and 6, each of the unit rows consists of four droplet discharge units 2 on one beam. In this embodiment, the distance between the center lines Y2-Y2 and Y3-Y3 of the unit rows is about a half of the length of the substrate 50 in the directions (A) in which the substrate is conveyed. As shown in FIG. 5, the substrate 50 moves right and left over about a quarter of its length in the directions A from its position where its bisector Q perpendicular to the directions A is positioned at the same distance from the center lines Y2-Y2 and Y3-Y3. This makes it possible to minimize the total distance over which the substrate 50 is conveyed by being reciprocated. The minimized distance results in the shortest time taken by the substrate 50 to be restored. However, it is not essential to strictly set the distance of the reciprocation in the directions A, but errors of about 20% are allowable. Even in such a case, the whole time-shortening effect can be increased.

As will be stated later on, three or more unit rows may be provided.

The length of the substrate 50 in the directions (A) in which it is conveyed may be represented by D. The distance between the unit rows may be represented by d. The number of unit rows may be represented by n. If D/n is not smaller than 0.8 d and not larger than 1.2 d (0.8 d≦D/n≦1.2 d), it is possible to shorten the time taken by the substrate 50 to be restored.

After the substrate 50 is restored, it is returned to its position in FIG. 4 and taken from the conveying stage 11 by the carrying robot (not shown). If the substrate 50 is a color filter substrate, it is put into a kiln so that the discharged material can be solidified.

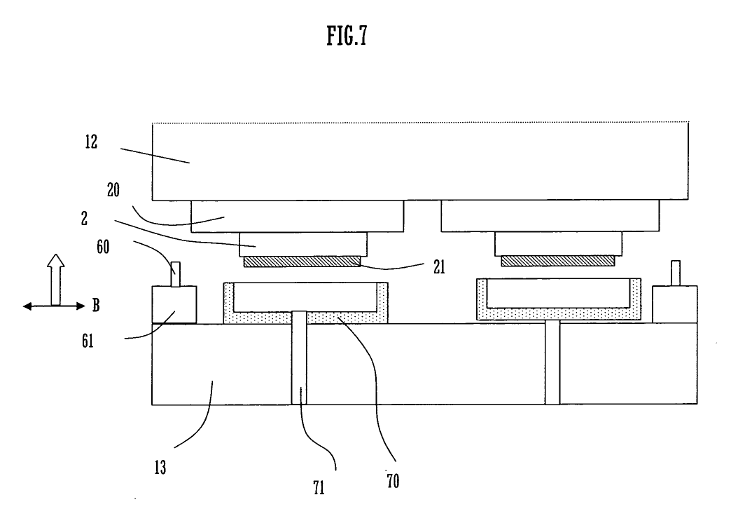

After droplets are discharged to the substrate 50, the beams 12 in FIG. 1 are shifted to the maintenance unit 13, where maintenance is done. FIG. 7 is schematic cross sections of the maintenance unit 13, one of the beams 12 shifted to positions over the unit 13, and droplet discharge units 2. The maintenance unit 13 consists of caps 70 in the form of recesses and a wiping mechanism, which consists of wiping blades 60 and blade holders 61. The maintenance unit 13 can move in the directions indicated by the white and black arrows in FIG. 7. The vertical movement of the maintenance unit 13 and the sliders 20 on the beams 12 over the unit 13 positions the sliders 20 and droplet discharge units 2. With the wiping blades 60 in contact with discharge elements 21, the maintenance unit 13 is moved right and left (in the directions B) in FIG. 7 so as to remove the droplets and dust remaining on the discharge faces of the elements 21. While the droplet applicator 1 is stopping or operating to restore its discharge function, the maintenance unit 13 is lifted so that each droplet discharge unit 2 can engage with one of the caps 70. Each cap 70 is connected to a pressure control pipe 71. The pressure control pipes 71 for the caps 70 are connected to a pressure control mechanism (not shown). If the pressure control mechanism is informed of the stopping of the droplet applicator 1, this mechanism makes each droplet discharge unit 2 enclosed in the associated cap 70. Subsequently, the pressure control mechanism makes the pressure control pipes 71 closed to shut off the inside of the caps 70 completely from the atmosphere. Likewise, if the pressure control mechanism is informed of the operation for restoring the discharge function, this mechanism makes each droplet discharge unit 2 enclosed in the associated cap 70. Subsequently, the pressure control mechanism causes a pressure mechanism to make suction through the pressure control pipes 71, making the inside of the caps 70 negative in pressure. This makes the nozzle holes 22 (FIG. 3) of the discharge element 21 cleaned with the liquid (ink) sucked through the holes.

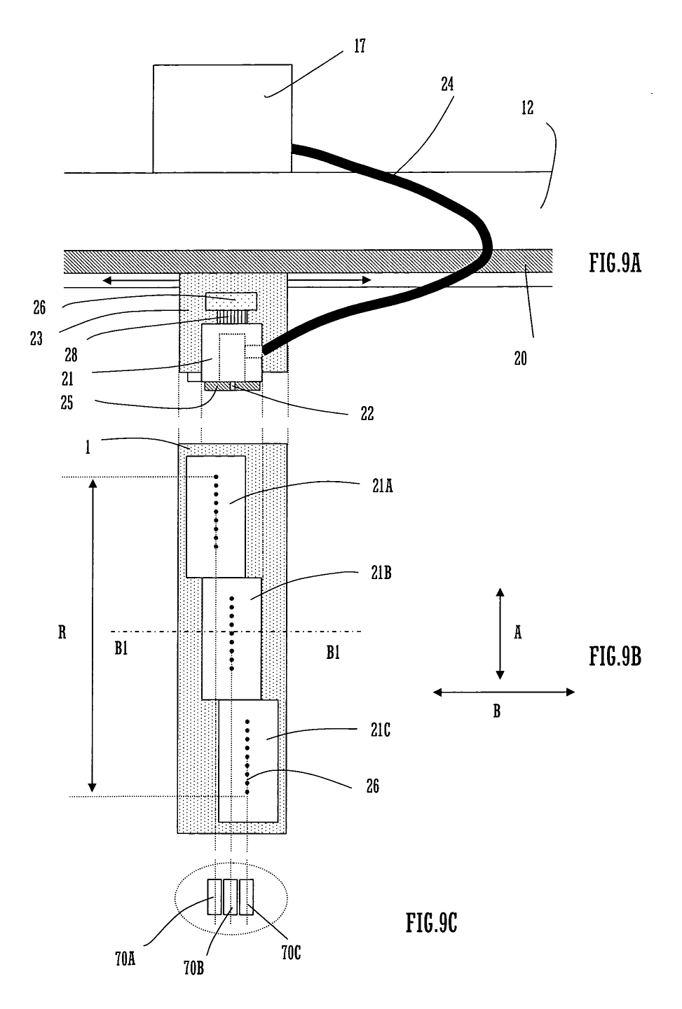

The structure of the droplet discharge units 2 will be described below with reference to FIG. 9.

FIG. 9(A) is a cross section of each droplet discharge unit 2. The droplet discharge units 2 are supported by the sliders 20, which are fitted to the beams 12. The droplet discharge units 2 can move in the directions B. Each droplet discharge unit 2 includes discharge elements 21, drive control circuits 26, connecting cables 28, and a casing 23, which contains these elements 21, circuits 26, and cables 28. The casing 23 moves on the associated slider 20. Each discharge element 21 is connected through a flexible tube 24 to a liquid (ink) tank 17, which is fixed to the associated beam 12. A nozzle plate 25 is bonded to the front face of each discharge element 21 and has nozzle holes 22 formed through it, which have a diameter of 10-20 μm. In this embodiment, the discharged liquid is ink and will be referred to below as ink.

Each discharge element 21 is made by forming grooves as ink chambers in a piezoelectric substrate and subsequently forming electrodes on portions of the partition walls between the grooves. If an electric field is applied to the electrodes on the partition walls on both sides of each of the ink chambers, the walls shear-deform. This generates discharge energy in the ink chamber, thereby discharging ink from the associated nozzle hole 22. The drive control circuits 26 are connected through cables (not shown) to a drive control system (not shown), which performs discharge control.

FIG. 9(B) is a bottom view of each droplet discharge unit 2. FIG. 9(A) is a cross section along line B1-B1 of FIG. 9(B). Each of the three discharge elements 21A, 21B and 21C, to which the associated nozzle plate 25 is bonded, is connected through the associated tube 24 to the associated ink tank 17 so that different ink materials can be supplied into the elements. With reference to FIG. 3, a description is provided of a process for discharging one kind of ink (liquid) droplets from one discharge element 21. However, by arraying the three discharge elements 21A, 21B and 21C, as shown in FIG. 9, it is possible for one droplet applicator 1 to discharge the different ink (liquid) materials at a time. The discharge elements 21A, 21B and 21C are offset at a specified distance in the directions B and can discharge droplets to three discharge regions 70A, 70B and 70C respectively on a substrate 50. This arrangement makes it possible to simultaneously repair adjacent defective pixels of different colors in a color filter substrate as described with reference to FIG. 3. In this arrangement, the distance R between the end nozzle holes 22 of each droplet discharge unit 2 occupies the most part of the range of disability H (FIG. 3(C)) and is about three times the distance between the end nozzle holes 22 of each droplet discharge unit 2 including only one discharge element 21.

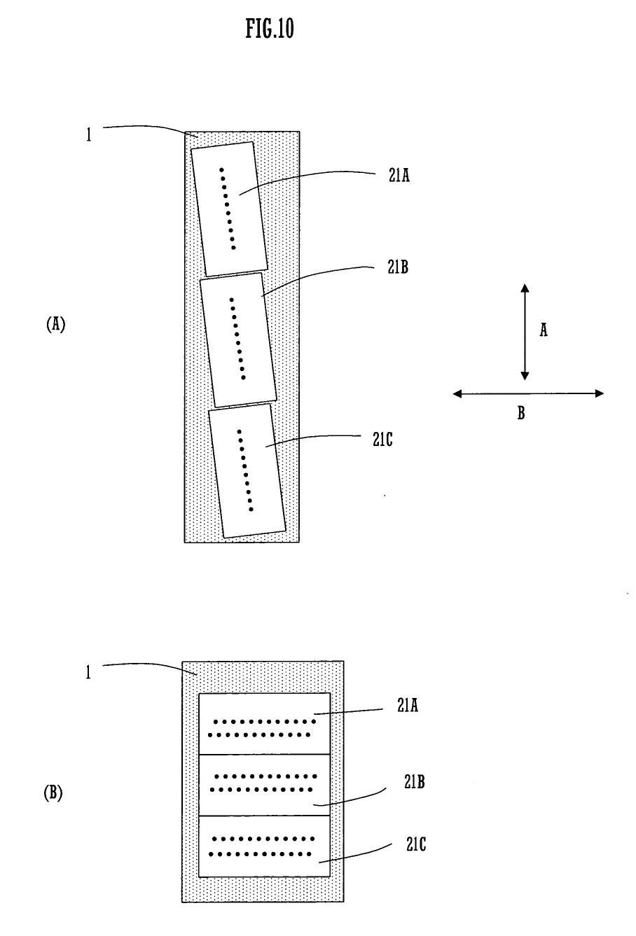

FIG. 10 shows other arrays of discharge elements 21. FIG. 10 (A) shows discharge elements 21 each having a nozzle hole row, which inclines slightly at an angle θ with the directions A. The nozzle holes of these discharge elements 21 are arrayed at a nozzle pitch p. The nozzle pitch P projected in the directions B is p times sin θ (P=p×sin θ), so that the pitch P in the directions B has the advantage of being denser than the actual nozzle pitch. There is no need to array these discharge elements 21 by positioning them accurately with respect to the directions B. This makes it easy to make droplet discharge units 2.

More effectively, each discharge element 21 may have 20-80 nozzle holes 22 formed at a pitch of 100-200 DPI (a density of 100-200 nozzle holes 22 arrayed at the same pitch per inch) and may incline at an angle of 3-10 degrees with the directions A (θ=3-10 degrees). The reason for this is that a droplet discharge unit 2 including an array of discharge elements 21 each having fewer nozzle holes 22 is narrower, so that the range of disability H (FIG. 3(C)) is narrower. If the 100-200 DPI discharge elements 21, which are made at low cost, incline at the angle θ of 3-10 degrees and make test discharges before the elements 21 are used, there is no need to position the elements 21 accurately relative to each other. In other words, discharge timing control based on the results of the test discharges enables the nozzle pitch projected in the directions B to be as dense as 5-35 μm. This makes it possible to manufacture droplet discharge units simply at low cost.

FIG. 10(B) shows three discharge elements 21 each having nozzle rows (two in FIG. 10(B)), which extend and are offset in the directions B so that the nozzle pitch projected in these directions can be dense.

As shown in FIGS. 10(A) and 10(B), the dense nozzle pitch projected in the directions B makes it possible to discharge ink droplets densely to desired spots on the substrate 50.

The droplet discharge units 2 can be driven by a known ink jet drive of the thermal type, the laminated piezoelectric type, the electrostatic type, or another type. The droplet discharge units 2 could be driven by another drive including a mechanism which can selectively discharge ink droplets.

In this embodiment, as shown in FIG. 2, the beams 12 supporting the droplet discharge units 2 can be shifted by the beam shifter 14, and the distance between the two beams 12 can be varied freely. In other words, the distance between the two unit rows can be varied freely. This makes it possible to optimize the distance between the unit rows according to the size of the substrate 50 in the directions (A) in which the substrate is conveyed.

Hereinbefore, a description has been provided of the repair of a defective pixel of one color in a color filter substrate. The droplet applicator 1 drops ink droplets into defects in a substrate, which are recesses formed in specified shape by radiating a laser beam or the like to spots on the substrate where dust has entered during the process for manufacturing the substrate, or where blank recesses have been formed, or other spots on the substrate. However, the use of the droplet applicator 1 is not limited to the restoration of a color filter substrate, but the applicator 1 can discharge droplets of ink or another liquid to desired spots on a substrate.

Even for larger substrates 50, the droplet applicator 1 embodying the present invention is not complicated, and there is no need to increase the number of non-operating nozzles of the applicator 1 as is the case with line head type apparatus. If the number of non-operating nozzles increased, the waste liquid necessary for maintenance would increase, and it would be difficult to uniformize the discharge from the nozzle holes 22.

The nozzle rows of the droplet discharge units 2 of the droplet applicator 1 according to this embodiment are substantially parallel to the directions (A) in which a substrate 50 is conveyed. This arrangement makes it possible to drop uniform discharge at high speed particularly into recesses.

In particular, for a color filter substrate or another substrate 50 the uniformity in thickness of which greatly influences the performance of its pixels, it is necessary to measure the droplet discharges from all the nozzle holes 22 in advance outside the droplet applicator 1 and discharge droplets from the holes while making discharge corrections. For example, in order to discharge droplets having a solid content of 10% into the recesses of 200×70×2 μm (depth), it is necessary to discharge (drop) about 300 pL. If the discharge corrections are made by varying the number of droplets, the corrections are more accurate for smaller volume of each of the droplets. However, if the droplets are small in volume, they need to increase in number. In this embodiment, the nozzle holes 22 are arrayed substantially in parallel to the directions A and used to discharge droplets, so that each nozzle hole 22 drops an amount of about 300/(the number of nozzle holes). This enables accurate discharge corrections without lowering the processing speed (the speed at which a substrate 50 is conveyed). The foregoing arrangement enables high speed processing even if no discharge correction is made.

Embodiment 2 of the present invention will be described below.

A droplet applicator 1 according to embodiment 2 differs from the droplet applicator 1 according to embodiment 1 in including:

a different number of beams 12;

droplet discharge units 2 fitted on side surfaces of the beams 12;

three unit rows; and

a maintenance unit 13 which does maintenance by shifting toward the beams 12.

Otherwise, the droplet applicator 1 according to embodiment 2 is identical in structure with the applicator 1 according to embodiment 1.

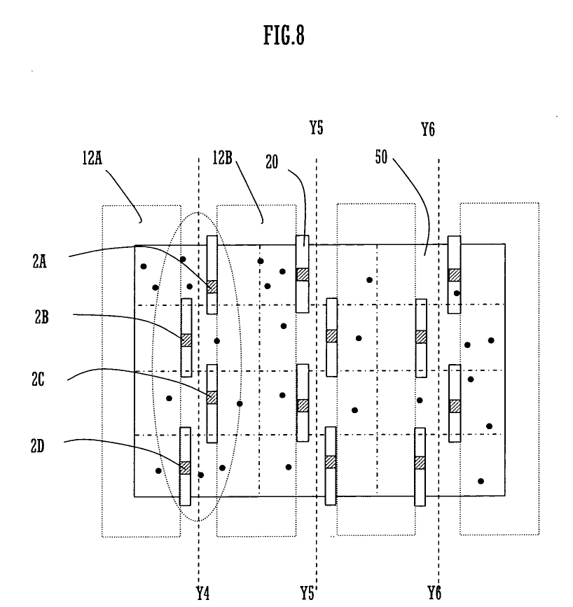

FIG. 8 corresponds to FIG. 5 of embodiment 1, showing the positional relation among the substrate 50, beams 12 and droplet discharge units 2 of the droplet applicator 1 according to embodiment 2. In embodiment 2, four beams 12 are substantially parallel to each other, each of which is fitted with sliders 20 on one or both of its side surfaces. Each slider 20 is fitted with a droplet discharge unit 2 on it. The droplet discharge units 2A-2D on side surfaces of the two beams 12A and 12B can move in the directions (B) perpendicular to the directions (A) in which the substrate 50 is conveyed. The range within which each of the droplet discharge units 2A-2D can move in the directions B overlaps with the range or ranges within which the adjacent unit or units 2 can move in these directions. The droplet discharge units 2 form unit arrays. Specifically, the droplet applicator 1 has a first unit array, a second unit array, and a third unit array. The center lines Y4-Y4, Y5-Y5 and Y6-Y6 of the first, second and third unit arrays respectively are spaced at regular intervals, which are about ⅓ of the length of the substrate 50 in the directions A. The substrate 50 reciprocates right and left over a distance from its position shown in FIG. 8. This distance is set at ⅙ of the length of the substrate 50 in the directions A.

The droplet applicators 1 according to embodiments 1 and 2 are described as having two and three unit rows respectively. The descriptions of these applicators 1 make it understood that it is preferable that, if a droplet applicator 1 has a number n of unit rows, and if a substrate 50 has a size D in the directions (A) in which it is conveyed, the center lines of the rows be spaced at intervals d of about D/n. It is also preferable that the substrate 50 be conveyed over a distance of about ½ n of the substrate size D. The distance is inversely proportional to the number of unit rows, so that the droplet applicator 1 can be smaller in size.

By making d nearly equal to D/n, it is possible to minimize the droplet applicator 1 in size. The difference between d and D/n may range between about +10% and −10%. In this case, without increasing the size of the droplet applicator 1, it is possible to reduce the area occupied by the applicator.

It is preferable that d be equal to D/n. If the difference between d and D/n ranges between about +20% and −20%, the processing time per substrate does not greatly increase, so that the tact time is shortened.

In embodiment 1, not only the conveying stage 11 but also the maintenance unit 13 is mounted on the slide rails 15, which lie on the base 10. The maintenance unit 13 can be moved in the same directions as the conveying stage 11 moves. In order to do maintenance, as stated above, the maintenance unit 13 can be moved along the slide rails 15 to a position under the droplet discharge units 2.

Embodiment 3 of the present invention will be described below.

A droplet applicator 1 according to embodiment 3 differs from the droplet applicator 1 according to embodiment 1 in including:

two beams 12;

droplet discharge units 2 fitted on the outer side surfaces of the beams 12; and

one unit row;

and also differs in that the beams 12 shift outward of the applicator when the droplet discharge units 2 are replaced.

Otherwise, the droplet applicator 1 according to embodiment 3 is identical in structure with the applicator 1 according to embodiment 1.

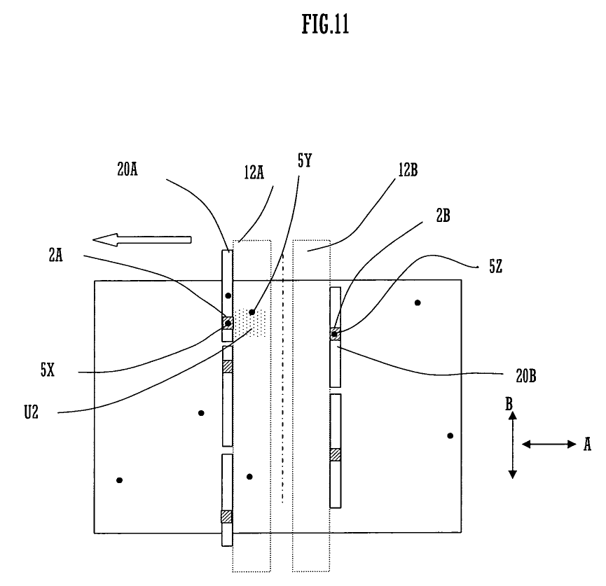

FIG. 11 is a perspective bottom view, which is similar to FIGS. 4-6, of the droplet applicator 1 according to embodiment 3, typically showing the positional relation among a substrate 50, the beams 12, and the sliders 20.

In this embodiment, the beams 12 are two in number. The left beam 12A is fitted with sliders 20 and droplet discharge units 2 on its left side surface. The right beam 12B is fitted with sliders 20 and droplet discharge units 2 on its right side surface. The droplet discharge units 2 can reciprocate freely in the sliders 20. The beams 12A and 12B are fitted with three and two droplet discharge units 2 respectively. Thus, the droplet applicator 1 is fitted with five droplet discharge units 2 in total on it.

The sliders 20, which are fitted with the five units, are mounted zigzag with respect to the substrate 50. The ranges of movability along the three sliders 20 on the left beam 12A overlap with the ranges of movability along the two sliders 20 on the right beam 12B in the directions (B: first directions) perpendicular to the directions (A) in which the substrate 50 is conveyed. The overlaps of the ranges should be as wide as possible. It is preferable that the total length of the overlaps be ⅓ or more of the total length of the sliders 20.

Thus, the sliders 20 are arrayed on the two beams 12A and 12B zigzag with respect to the substrate 50. The ranges of movability in the (first) directions B along the sliders 20 on the beam 12A overlap in these directions with the ranges of movability in these directions along the sliders 20 on the second beam 12B. This makes it possible to drop ink droplets efficiently onto adjacent spots, thereby making it possible to shorten the tact time.

As stated above, while the substrate 50 is reciprocating, the droplet discharge units 2 drop ink droplets. While the substrate 50 is moving to the left (in the directions A) in FIG. 11, the droplet discharge unit 2A reaches a position over a defect 5X in the substrate 50 and then drops ink droplets. When the droplet discharge unit 2A drops ink droplets to the defect 5X, it can drop no ink droplet to a defect 5Y in a zone of irreparability U2 on the substrate 50. The droplet discharge unit 2B backward with respect to the direction in which the substrate 50 is moving moves within a range overlapping with the range within which the unit 2A moves. The droplet discharge unit 2B is offset in the directions A from the unit 2A. Accordingly, even after the droplet discharge unit 2A drops ink droplets to the defect 5X, the unit 2B can reach the defect 5Y.

Because the two droplet discharge units 2A and 2B, which move within the overlapping ranges, are offset in the directions (A) in which the substrate 50 is conveyed, ink droplets can be dropped efficiently to defects in the substrate 50 even if the defects are adjacent to each other. In particular, this arrangement brings about a great effect in the latter half of the process for dropping ink droplets while the substrate 50 is reciprocating a number of times.

By arranging the sliders 20 on the two beams 12A and 12B zigzag with respect to the substrate 50, it is possible to drop ink droplets efficiently by means of a small number of droplet discharge units 2.

In this embodiment, the droplet discharge units 2 are fitted to the outer side surfaces of the two beams 12A and 12B. By thus arranging the droplet discharge units 2 zigzag in two rows and fitting the units to the outer side surfaces of the beams, it is possible to easily do maintenance.

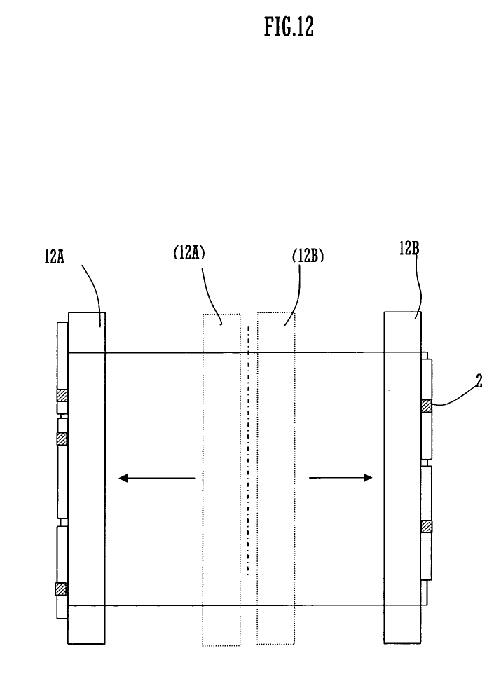

In this embodiment, in order for the droplet discharge units 2A and 2B to be replaced, the two beams 12A and 12B can, as shown in FIG. 12, shift to the ends of the droplet applicator 1. The beams 12A and 12B can be shifted by a beam shifter 14 as mentioned for embodiment 2 as well.

Because the beams 12, which are fitted with droplet discharge units 2, shift toward the ends of the droplet applicator 1 in order for the units 2 to be replaced, the units 2 do not need to be replaced over the conveying stage 11, and the degree of freedom of replacing operation is high. This makes it possible to improve the operation safety and the efficiency of replacing operation.

As described hereinbefore, the droplet discharge units 2 of the droplet applicators 1 described as preferred embodiments of the present invention can move in the directions (B) perpendicular to the conveying directions (A). However, the present invention is not limited to what has a unit array. It is essential that the droplet applicator according to the present invention be fitted with two or more droplet discharge units 2 independently movable in the directions (B) perpendicular to the directions in which a substrate 50 is conveyed.

A single beam 12 might be fitted substantially in parallel to the conveying directions (A) over the conveying stage 11. In FIG. 11, a single beam 12 might be fitted with sliders 20A and 20B on its left and right side surfaces respectively. As is the case with FIG. 11, the sliders 20A and 20B might be arranged zigzag with respect to the substrate 50. Accordingly, the ranges of movability along the sliders 20A arranged in the directions (B) perpendicular to the conveying directions on the left side surface of the beam 12 would overlap in the directions B with the ranges of movability along the sliders 20B arranged in the directions B on the right side surface of the beam 12. This arrangement as well would make it possible to drop ink droplets efficiently to adjacent defects.

The droplet discharge units 2 are ink jet head elements made of piezoelectric material but might not be limited to them. The droplet discharge units 2 might be elements of the thermal type, the laminated piezoelectric type, the electrostatic type, or another known ink jet type. The droplet discharge units 2 might be elements of another type which are units including mechanisms capable of selectively discharging droplets.

In embodiments 1-3, each of the sliders supports one droplet discharge unit 2 but might support two or more droplet discharge units 2, which could be driven independently.

The droplet applicators 1 according to embodiments 1-3 repair defects produced in color filter substrates for liquid crystal displays etc. during the process for manufacturing the substrates. The droplet applicators 1 merely exemplify an apparatus which can discharge droplets at high speed to desired spots on a substrate 50.

In comparison with line type apparatus having a line of ink jet heads, the droplet applicators 1 are higher in use (utility) value for substrates larger in area.

### INDUSTRIAL APPLICABILITY

The present invention can be applied to:

apparatus for describing a wiring pattern on a substrate by discharging electrically conductive ink onto the substrate;

apparatus for manufacturing an organic EL (electronic luminescence) display by discharging a material for an organic EL onto a substrate;

apparatus for repairing defects in an organic EL display;

apparatus for printing an image on a large signboard or the like, or restoring the image on a large signboard or the like; and

other manufacturing apparatus to which ink jet technology is applied.

1-12. (canceled)

13. A droplet discharger comprising:
a plurality of sliding mechanisms facing a substrate;
the sliding mechanisms each being associated with one of the regions into which the substrate is divided in first directions; and
droplet discharge units each fitted on one of the sliding mechanisms;
the droplet discharge units being adapted to discharge droplets onto the substrate;
the droplet discharge units each being independently movable on the associated sliding mechanism.

14. A droplet discharger as claimed in claim 13, wherein the sliding mechanisms form rows of sliding mechanisms extending in the first directions, and wherein adjacent rows of sliding mechanisms are spaced in second directions perpendicular to the first directions.

15. A droplet discharger as claimed in claim 14, wherein the sliding mechanisms adjoining in the second directions in each of the rows of sliding mechanisms overlap in the first directions, the droplet discharge units each being movable within a range of movability on the associated sliding mechanism, and wherein the ranges of movability on the adjoining sliding mechanisms overlap.

16. A droplet discharger as claimed in claim 15, wherein the sliding mechanisms in each of the rows of sliding mechanisms are spaced in a line in the first directions.

17. A droplet discharger as claimed in claim 16, further comprising:
carriers carrying the rows of sliding mechanisms;
the carriers being shiftable in the second directions;
the carriers each being fitted with one of the rows of sliding mechanisms adjoining in the second directions.

18. A droplet discharger as claimed in claim 16, further comprising:
a plurality of carriers carrying the rows of sliding mechanisms;
the carriers being shiftable in the second directions;
the carriers each being fitted with one of the rows of sliding mechanisms on one side thereof in the second directions.

19. A droplet discharger as claimed in claim 17, wherein the droplet discharge units have a plurality of droplet discharge nozzles for discharging droplets, the nozzles being arrayed in the second directions.

20. A droplet discharger as claimed in claim 16, wherein the droplet discharge nozzles are arrayed at an angle with the second directions.

21. A droplet applicator comprising:
a droplet discharger as claimed in claim 13, and
a moving means for moving the droplet discharger in the second directions relative to the substrate;
the droplet discharge units being adapted to be relatively moved to any positions over the substrate and apply droplets to the substrate.

22. A repairing apparatus comprising:
a droplet discharger as claimed in claim 13, and a moving means for moving the droplet discharger in the second directions relative to the substrate;
the droplet discharge units being adapted to be relatively moved to defects in the substrate, and to discharge droplets onto the defects so as to repair the defects.

23. A repairing apparatus as claimed in claim 22, wherein the moving means reciprocates the droplet discharger in the second directions relative to the substrate.

24. A method for manufacturing a color filter substrate by:
using a droplet applicator as claimed in claim 21, the substrate being a color filter substrate, the droplet discharge units being units for discharging color droplets; and
discharging color droplets onto the color filter substrate.

25. A method for manufacturing a color filter substrate by:
using a repairing apparatus as claimed in claim 22, the substrate being a color filter substrate having a defect, the droplet discharge units being units for discharging color droplets; and
discharging color droplets onto the defect so as to repair the defect.
